(19) United States
(12) Patent Application Publication
(10) Pub. No.: US 2008/0027776 A1
(43) Pub. Date: Jan. 31, 2008

(54) PROJECT TASK DRIVERS PANE

(75) Inventors: Alexander A. Sourov, Seattle, WA (US); Clifford J. Watson, Bellevue, WA (US); Daniil Magdalin, Kirkland, WA (US); Heather J. O'Cull, Seattle, WA (US); Sundaravadivelan Paranthaman, Sammamish, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/460,834

(22) Filed: Jul. 28, 2006

(51) Int. Cl. G06F 9/46

(52) U.S. Cl. 705/8

(57) ABSTRACT

A task driver system for explaining the factors contributing to a task's scheduling for a project to a project manager and for displaying and navigating between related tasks is provided. The system receives information defining a set of tasks for the project. For each task, the system first analyzes scheduling considerations for the task. Based on the analysis, the task driver system determines a schedule for the task that satisfies the scheduling considerations. Finally, the system stores information identifying the factors that contributed to the schedule for the task as task drivers.

### BACKGROUND

Projects are endeavors involving multiple tasks that are together completed for a purpose, such as creating products or services. Projects include, e.g., erecting bridges or buildings, creating software, and shooting movies. Tasks involved in a project for erecting a building may include, e.g., acquiring materials, hiring a general contractor, and laying a foundation. Each project or some of its tasks may have various constraints such as time, cost, and scope. For example, constraints may include a specified start or finish date and availability of resources such as people and equipment that may perform the tasks. As an example, an electrician may only be available during a certain period. Other constraints may include the desired quality, features, and functions. As an example, an architect may specify a number of windows. A subset of the project's tasks may also have dependencies on other tasks. As an example, materials may need to be acquired before the foundation can be laid. These considerations, comprising at least constraints and dependencies, may be analyzed when determining a project schedule.

A project manager determines and manages a project's schedule by analyzing and balancing the considerations. Analyzing considerations may involve, e.g., determining in what order tasks are to be performed, which resources will perform the tasks, and the duration of the tasks. Balancing considerations may involve, e.g., adjusting or reducing one or more of the considerations to affect another consideration. As an example, the project manager may add resources or remove features to reduce the total time for a task or project that is behind schedule. Alternatively, if project scope must be increased because of new requirements, then resources may need to be increased so that a task or the project does not become delayed.

Project managers may use project management software such as MICROSOFT PROJECT to assist in managing their projects. A project manager may use project management software to track all information relating to a project such as tasks, project management software to track all information relating to a project such as tasks, duration of tasks, resources, and other considerations. When this project information is specified, the project management software may automatically provide project feedback, such as by adjusting completion time of a task based on adjustments to considerations, graphically displaying relationships between the project's tasks, and estimating completion dates and costs based on indicated progress. As an example, if a project comprises three tasks and the project ends at the completion of a task, the project may end sooner if the project manager assigns an additional resource to the task. Thus, the project manager is able to use the project management software to create, predict, analyze, and manage project schedules.

A project manager may provide as input to project management software a variety of information relevant to a project. This information may include work periods, tasks, resources, and progress. Work period information may include, e.g., work days and work hours. Task information may include, e.g., names, durations, relationships to other tasks, and resources assigned to the tasks. Resource information may include, e.g., types, names, costs, and work hours. Progress information may include an initial project plan (sometimes referred to as a “baseline”), task completion, and actual values. Actual values describe previously completed portions of the project plan. Examples of actual values include, e.g., start date, finish date, duration, and cost. The project management software may use this information to determine an initial project schedule.

When the project manager provides additional input or adjusts one of the previously provided inputs, a scheduler component of the project management software may reschedule one or more tasks automatically. As an example, when a project has many tasks with multiple dependencies or constraints, a change to the expected duration of a task may cause the scheduler component to reschedule, e.g., the start or finish dates of other tasks, and potentially the overall project schedule. A dependency or constraint that impacts the scheduling of a particular task is called a task driver for that task. In a complicated project, the project manager may not understand what the drivers are for a particular task, why the adjustment caused the scheduler component to reschedule other tasks, how the rescheduling was determined, or how to resolve issues resulting from the adjustment. When a project manager does not understand why the project management software reschedules tasks, the project manager may be less comfortable with schedules determined by the project management software, and may be less likely to continue to use the project management software.

### SUMMARY

A task driver system for explaining the factors contributing to a task's scheduling and for displaying and navigating between related tasks is provided. The system receives information defining a set of tasks for the project. For each task, the system first analyzes scheduling considerations for the task. Based on the analysis, the task driver system generates a schedule for the task that satisfies the scheduling considerations. During the generation of the schedule, the system stores information identifying the factors that contributed to the schedule for the task as task drivers. The system can then display the task drivers and allow a project manager to navigate through the scheduled tasks to view the factors driving the scheduling of a particular task.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates the components of the task driver system in one embodiment.

FIG. 2 illustrates a user interface of project management software in one embodiment.

FIG. 3 illustrates a user interface for the task driver system in one embodiment.

FIG. 4 illustrates a user interface of the task driver system for displaying task driver details in one embodiment.

FIG. 5 is a flow diagram illustrating an embodiment of a schedule_tasks routine performed by the scheduling engine component.

FIG. 6 is a flow diagram illustrating the processing of the task driver display component in one embodiment.

FIG. 7 is a flow diagram illustrating the processing of the scheduling engine component to record drivers in one embodiment.

FIG. 8 is a block diagram illustrating an embodiment of a data structure relating to a project and its tasks.

FIG. 9 is a block diagram illustrating an embodiment of a data structure relating to a task.

### DETAILED DESCRIPTION

A task driver system for explaining the factors contributing to a task's scheduling and for displaying and navigating between related tasks is provided. In one embodiment, the task driver system stores scheduling considerations for a project. First, the system receives information defining a set of tasks for the project. For example, if the project is a construction project, there may be a task for ordering materials, a task for preparing the work site, a task for constructing the structure, and a task for cleaning up the work site. For each task, the system first analyzes scheduling considerations for the task. For example, with respect to the construction project, constructing the structure cannot begin until the materials have been ordered and received. On the other hand, preparing the work site may be able to proceed before materials are available. Based on the analysis, the task driver system generates a schedule for the task that satisfies the scheduling considerations. For example, if constructing the structure cannot begin until the materials have been received, then the constructing task will be scheduled after the ordering materials task. The ordering materials task may also be given a duration that reflects the expected amount of time required to receive the materials once they are ordered. During the generation of the schedule, the system stores information identifying the factors that contributed to the schedule for the task as task drivers. For example, the ordering materials task caused the constructing the structure task to be scheduled later, so ordering materials will be stored as a task driver for the constructing task. Other factors may also be drivers for the task. For example, if there is a hire workers task in the project, this task could also be a task driver for the constructing task, and would be stored with other task drivers. The system can then display the task drivers and allow a project manager to navigate through the scheduled tasks to view the factors driving the scheduling of a particular task.

In some embodiments, the task driver system provides a user interface for displaying task driver information. The system may allow a particular task to be selected by a user, and then display the drivers for the scheduling of the selected task in a task drivers window. For example, if a user selects the “pour foundation” task of a house building project, the task pane may display predecessor tasks (such as hiring workers), resource calendars (such as waiting for a concrete truck to be available), or other factors such as those described above that contribute to the scheduling of a task. The task driver user interface may display a maximum number of task drivers for a selected task. For example, the user interface may only display a maximum of five drivers for a selected task. If the number of task drivers exceeds the maximum number, then the user interface may show the total number of task drivers, e.g., seven, rather than a list of task drivers. The user interface may also display a maximum number of task drivers for each category of task driver. For example, if there are two predecessor task task drivers and seven resource calendar task drivers, the user interface may list both of the predecessor tasks, but summarize the resource calendar task drivers by displaying only the number seven associated with the number of resource calendar drivers.

In some embodiments, the task driver user interface supports selecting a task driver to obtain additional information about the driver. For example, if the driver is the start or end date of a predecessor task, then the user can navigate to that predecessor task to see what drivers are affecting the scheduling for the predecessor task. If the driver is a resource calendar, then the user can select the driver to see a calendar control displaying the dates the resource is available. The user interface may allow users to navigate forward and backward through a chain of related drivers using controls provided by the user interface so that the user can browse through various tasks in the project to understand which tasks have constraints that could be modified to improve the project schedule. This type of navigation allows a project manager to quickly drill down into problem tasks to find the root task that is delaying the project, or to zoom out from a particular task to determine which related tasks are impacting the task's schedule.

In some embodiments, a scheduling component of the task driver system provides a mechanism (e.g., an application programming interface) for registering listeners that are notified when the schedule has changed. The user interface can use this mechanism to automatically update the display when changes are made that affect the scheduling of a task. By integrating this mechanism within the scheduling component, it is not necessary for the user interface to periodically navigate the entire project schedule looking for changed task information. The change notification may also include information about the information or task that changed.

Many factors may affect the scheduling for a task. For example, a task may have a constraint specifying a start-no-earlier date that specifies that the task cannot start before a specified date, a finish-no-earlier date that specifies that the task cannot finish before a specified date, a must-start date that specifies a date that the task must have started by, or a must-finish date that specifies a date that the task must have finished by. These constraints can be set by the project manager, or determined automatically such as by the availability of a resource. Constraints determined based on the availability of a resource generally result in leveling delay being added to the schedule. For example, it may be more costly to rent a needed piece of construction equipment during the month of July, so a project manager may set a must-finish date prior to July 1 for tasks requiring that equipment. Another factor that can affect the scheduling of a task is an actual start date. The project management software is often used throughout the project, and at some point a particular task may have already started such that there is no longer flexibility to move that task around in the schedule, because it would be an error to schedule the task in the past. Therefore, an actual start date indicates when the task actually started. Another factor that can affect the scheduling of a task is a predecessor task, which can be of type finish-to-start, finish-to-finish, start-to-finish, or start-to-start. A finish-to-start predecessor task indicates that the predecessor task must finish before the dependent task can start. Similarly, a finish-to-finish task indicates that the predecessor task must finish before the dependent task can finish, and so on. A predecessor tasks may also have lag time specified between it and the dependent task. For example, the dependent task may not be able to start until the predecessor task has finished and two days have passed. Another factor that may affect the scheduling of a task is a summary/subtask relationship. A set of tasks may be grouped into a summary task that contains each of the subtasks to facilitate scheduling at a higher level. For example, if the project is building a house, there may be a summary task for the plumbing work, and subtasks within that task specifying installation of various bathroom faucets, the kitchen sink, and so on. Summary tasks may have interdependencies, such as electrical work not being able to begin before the walls of the house are framed, that impact each task's schedule. Another factor that can affect task scheduling is leveling delay. Leveling delay is used to spread out work among resources so that a particular resource is not overscheduled. For example, leveling delay can ensure that a single worker does not get scheduled to work over 80 hours a week. Finally, resource calendars may affect the scheduling of a task. A resource calendar specifies when a resource is available to work. For example, for a worker, the calendar could specify normal work hours during a day, or could indicate unavailability of the worker on a holiday. The calendar might also reflect local ordinances. For example a resource calendar for a bull dozer might reflect certain hours during which loud machinery cannot be used. Task and project calendars could also affect the scheduling of a task. For example, during the summer the project calendar may shift to have longer work hours each day and have Fridays off.

In some embodiments, the scheduling component of the task driver system traverses the tasks when any task in the schedule is changed to determine if the scheduling of any task has been impacted by the change. If the change will affect the scheduling, such as the start date, then the reason for the new start date is stored as a task driver. When the scheduling component discovers a new task driver for a task, it examines the previous set of task drivers for the task to see if the new driver will cause an earlier start date. If the new driver will cause an earlier start date, then the previous drivers are replaced by the new driver. If the new driver will cause the same start date, then the driver is added to the existing list of drivers for the task. A task can have many drivers that affect the task's start date. For example, a predecessor task and a calendar could both be driving a task's start date.

In some embodiments, the task driver system provides a programmable object model for obtaining task driver information programmatically. A driver object may allow enumerating task drivers and provide for navigation between drivers affecting the start date of a task. The object model provides information to other programs similar to the information available to users through the user interface.

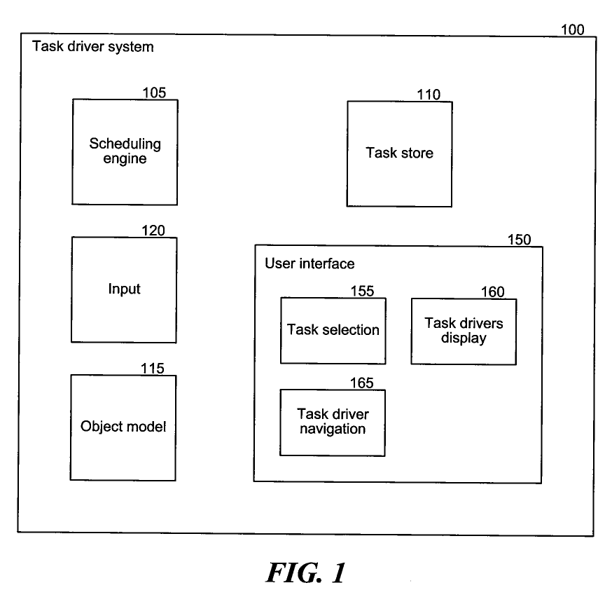

Turning now to the figures, FIGS. 1-9 illustrate various aspects of the task driver system incorporating the techniques described herein.

FIG. 1 is a block diagram that illustrates the components of the task driver system in one embodiment. The task driver system 100 contains a scheduling engine component 105, a task store component 110, an object model component 115, an input component 120, and a user interface component 150.

The scheduling engine component 105 may determine a schedule for each task based on data received by the input component. The scheduling engine component 105 may also determine a schedule for tasks based on schedule considerations, such as constraints or dependencies relating to other tasks. Other scheduling considerations may include, e.g., task constraints, actual values that have been reported on a task, start or finish dates of the project or its tasks, status dates for the project or its tasks, dependencies on other projects, or dependencies on milestones or phases within the project or other projects. The scheduling engine component 105 may also determine a schedule for tasks based on operations performed by a user, such as when leveling resources. The user may level resources to, e.g., ensure that a resource is not assigned to more tasks than the resource is capable of completing. When the scheduling engine component 105 determines a schedule for each task, it may store an indication of an explanation for the task's schedule. As an example, the scheduling engine component 105 may store an indication of an explanation relating to a primary consideration, or driver, for determining a schedule for the task. A primary consideration for determining a schedule for a task is a consideration that is actually used to determine the schedule for the task from a subset of considerations that could be used. As an example, when a successor task can begin only after three other predecessor tasks end, the primary consideration may be the predecessor task with the last completion date. Primary considerations may include tasks that are on a critical path. A critical path is a subset of tasks that, if delayed, could delay the project with which the tasks are associated.

The task store component 110 stores the tasks that make up the project and information associated with the tasks, such as the determinations made by the scheduling engine 105 about when the tasks should be scheduled and the current list of drivers for each task. The object model component 115 provides programmatic access to the task driver system. The input component 120 may receive data from a user or other software. The user may provide data using any of a number of user interface elements of the project management software. As an example, the user may type information using a keyboard. Alternatively, the user may retrieve information from storage, such as by retrieving a previously stored schedule. Other software may provide data using an application program interface (“API”) of the project management software or through the object model component. The input component may store the received data in a schedule file, such as in primary storage (e.g., random access memory) or in secondary storage (e.g., hard disk).

The user interface component 150 provides a display for interaction with the user. The user interface component 150 contains a task selection subcomponent 155, a task drivers display subcomponent 160, and a task driver navigation subcomponent 165. The task selection subcomponent 155 lists tasks that are part of the project and allows a user to select a particular task for which the user would like more information. The task drivers display subcomponent 160 displays the drivers for the selected task. The task driver navigation subcomponent 165 allows the user to select a task driver to find more information about that driver, and may also allow the user to navigate a chain of tasks and drivers to visually determine the interaction among related tasks. The user interface component 150 may provide output of schedule information in a variety of means. As examples, the output component may provide schedule information in a Gantt chart, report, or table, or by using an API of other software to communicate the schedule information to the other software.

The computing device on which the system is implemented may include a central processing unit, memory, input devices (e.g., keyboard and pointing devices), output devices (e.g., display devices), and storage devices (e.g., disk drives). The memory and storage devices are computer-readable media that may contain instructions that implement the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, hand-held or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

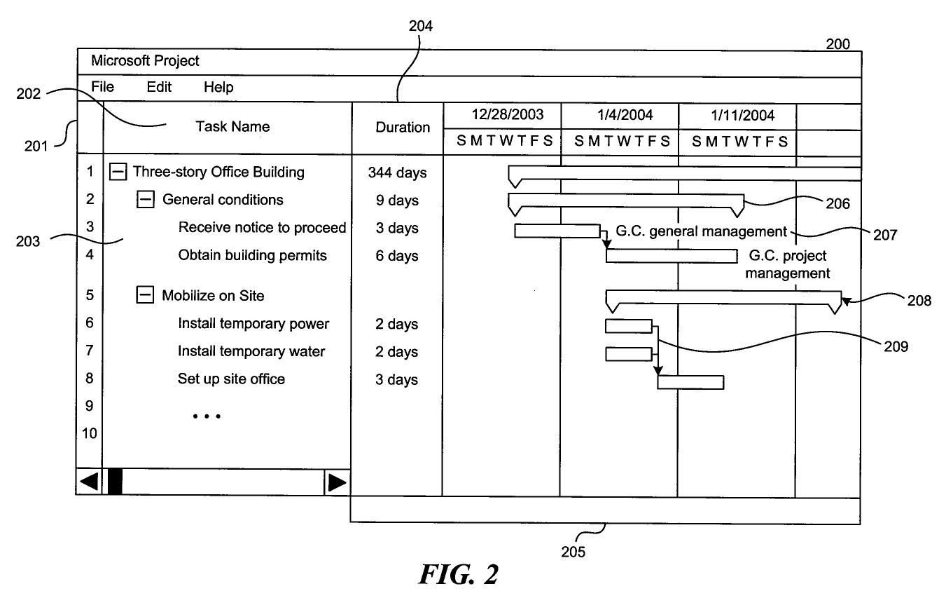

FIG. 2 illustrates a user interface of project management software in one embodiment. The project management software may use a windowing environment such as MICROSOFT WINDOWS. The main window of the project management software 200 comprises a textual area for textually displaying and receiving information, and a graphical area for graphically displaying and receiving information. As an example, the textual area may display information relating to tasks such as a number 201, a name 202, and a duration 204. As a further example, the graphical area may display information relating to tasks and their schedule as a Gantt chart 205. The textual area and the graphical area may together be referred to as a project plan window.

A user may be able to input information directly into the textual area by selecting a row, e.g., row 203 corresponding to task number 3, and typing information or performing other user interface operations in a manner generally similar to that which would be performed when using spreadsheet software. As examples, the user may be able to type a name or description for a task, a duration for the task, and indicate that the task is a subtask of a summary task 206.

Each task may have one or more resources assigned to the task. These resources may be displayed in the Gantt chart adjacent to the bar for the task, such as resource 207. In the illustrated example, a “G.C. general management” resource is assigned to task number 3.

Tasks may be linked with one another to indicate time-related dependencies. As an example, a successor task may only be capable of beginning after a predecessor task is completed. This relationship between predecessor and successor tasks may be referred to as a dependency. A dependency that causes a successor task to begin after a predecessor task ends may be referred to as a finish-to-start dependency. When tasks have a time-related dependency (e.g., a finish-to-start or other dependency), the project management software may indicate the dependency on the Gantt chart using an arrow, such as arrow 209. Other time-related dependencies include, e.g., start-to-start, finish-to-finish, and start-to-finish (not shown). A start-to-start dependency may be used when two tasks should start at the same time; a finish-to-finish dependency may be used when two tasks should finish at the same time; and a start-to-finish dependency may be used when the start date of a predecessor task determines the finish date of a successor task.

The user may be able to set or modify schedule information relating to a task (e.g., a constraint or dependency) using bars of the Gantt chart. As an example, the user may drag a left or right boundary of the bar 208 to change the associated task's start date or end date. As a further example, the user may be able to drag and drop the bar to indicate that the task is a sub-task of a summary task (e.g., by moving the bar's position vertically) or change the task's schedule (e.g., by moving the bar's position horizontally).

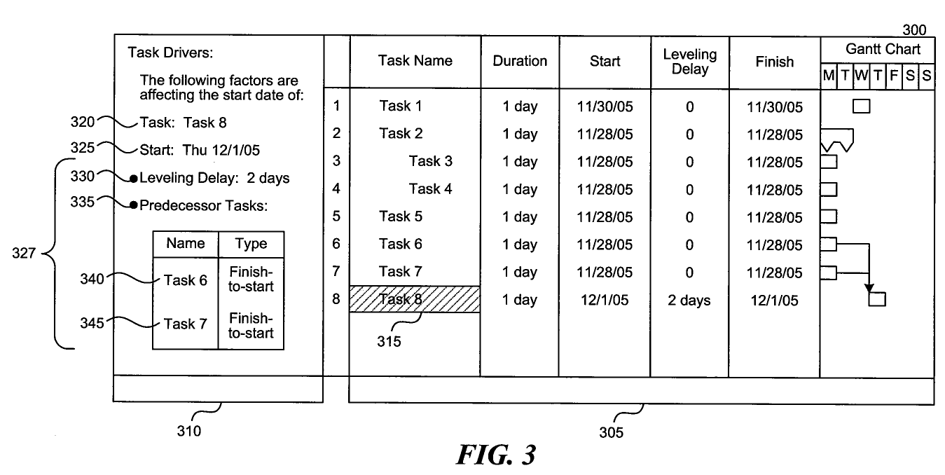

FIG. 3 illustrates a user interface for the task driver system in one embodiment. The user interface 300 contains a list of tasks 305 and a task drivers pane 310. The list of tasks 305 lists the tasks that make up the project. For example, one task is named “Task 1,” has a duration of 1 day, is scheduled to start on Nov. 30, 2005, has no leveling delay, and is expected to finish on Nov. 30, 2005. The list of tasks 305 contains a highlighted task 315, and the task drivers pane 310 is displaying details about the highlighted task 315. The task drivers pane contains the task's name 320, the start date 325 determined by the scheduling component, and a list of task drivers 327 affecting the start date of the task. The first task driver is a leveling delay 330 of 2 days. The remaining two task drivers, predecessor tasks 335, are grouped together by their type. The first predecessor task 340 is Task 6, and the second predecessor task 345 is Task 7. Both are of type “finish-to-start” indicating that they must finish before Task 8 can start. The list of task drivers 327 indicates that Task 8 could not be scheduled earlier without scheduling both Task 6 and Task 7 earlier, as well as causing the other work to be distributed in a way that reduces the leveling delay. The task drivers pane 310 may allow the user to select some of the drivers to view additional details.

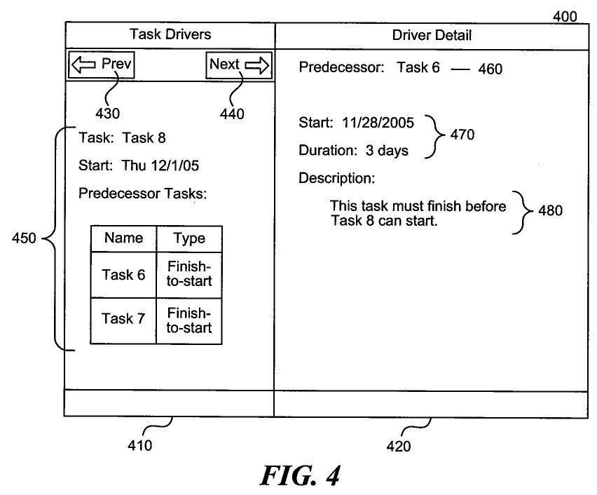

FIG. 4 illustrates a user interface of the task driver system for displaying task driver details in one embodiment. The user interface 400 contains an active task pane 410 and a task driver detail pane 420. The active task pane 410 displays information about a currently selected task. For example, the active task pane 410 may contain task details 450 including the name of the task, the task's start date, and a list of task drivers affecting the scheduling of the task. The active task pane may also contain navigation buttons, such as a previous button 430 and a back button 440, that allow navigating through the list of task drivers affecting the scheduling of the task to see additional details about the drivers. The task driver detail pane 420 displays information about the currently selected task driver. For example, the task driver detail pane 420 indicates that the currently selected driver's type 460 is a predecessor task identified as “Task 6.” Additional details 470 about the task, such as its start date and duration may also be displayed. Finally, a description 480, explaining the task driver's effect on the scheduling of the active task may also be displayed.

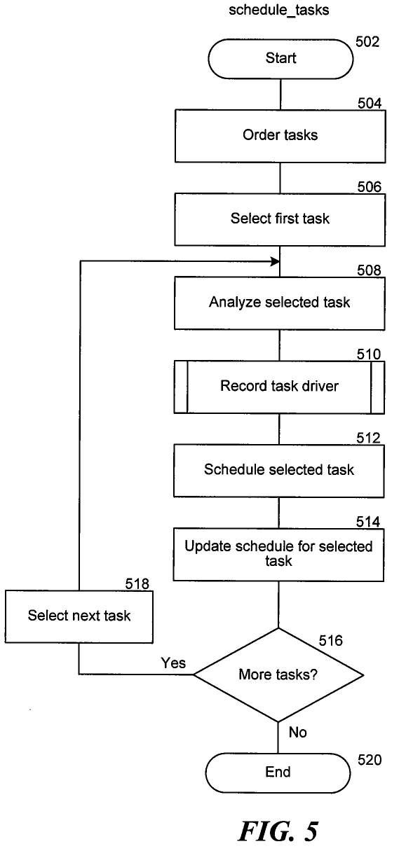

FIG. 5 is a flow diagram illustrating an embodiment of a schedule_tasks routine performed by the scheduling engine component. The routine begins at block 502. At block 504, the routine may order tasks for scheduling. Ordering the tasks for scheduling may involve placing predecessor tasks earlier in the order than successor tasks, which may cause scheduling to be performed for predecessor tasks before successor tasks. At block 506, the routine selects the first of the ordered tasks. In blocks 508-514, the routine may determine drivers for a subset of tasks, record information relating to the scheduling for the tasks, and determine a schedule for the tasks. The scheduling for the tasks may include an indication of drivers affecting the scheduling of the task. At block 508, the routine may analyze the selected task. Analyzing the selected task may include, e.g., determining which of a set (or subset) of considerations for the selected task is a driver for the task. As an example, a predecessor task that ends last may be a driver for a successor task that has a finish-to-start dependency on the predecessor task. At block 510, the routine may store a record of the drivers affecting the task's scheduling. As an example, the routine may store the indication in a data structure comprising data relating to the task. By storing the indication at the time of determining a schedule for the task, an accurate explanation for the task's schedule can be preserved.

At block 512, the routine may determine a schedule for the selected task. The routine may call a subroutine of the scheduling engine component or an altogether different component to determine the schedule for the task. At block 514, the routine may update schedule information for the selected task. At block 512, the routine may store the schedule determined in a data structure associated with the task. At block 516, the routine may determine whether there are additional tasks to analyze. If there are additional tasks, the routine continues at block 518. Otherwise, the routine continues at block 520. At block 518, the routine selects the next task and then continues at block 508. At block 520, the routine returns to its caller. By performing these steps, the scheduler component may have determined a schedule for each task of a project and may also have indicated an explanation for determining the schedule.

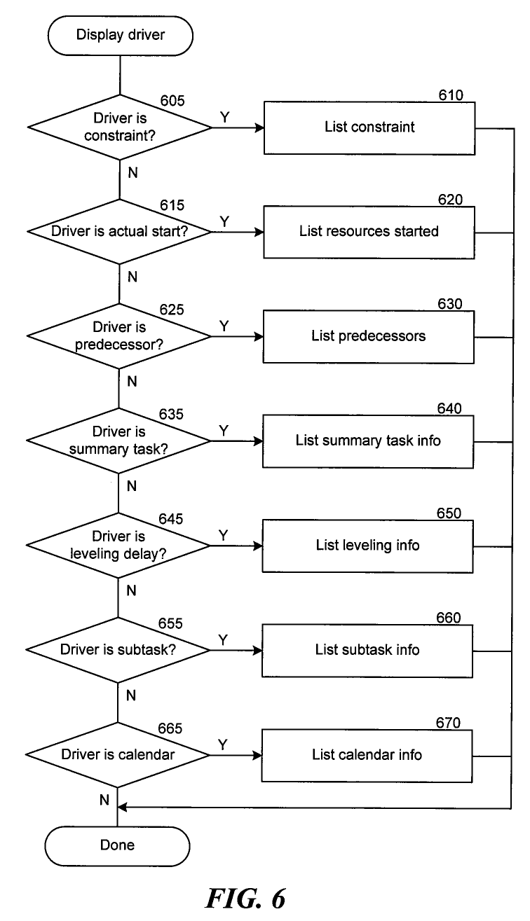

FIG. 6 is a flow diagram illustrating the processing of the task driver display component in one embodiment. The component is invoked for each task driver when a task is selected to render the task drivers in the user interface. In decision block 605, if the task driver is a constraint, then the component continues at block 610, else the component continues at block 615. In block 610 the component lists information about the constraint and completes. In decision block 615, if the task driver is an actual start date, then the component continues at block 620, else the component continues at block 625. In block 620, the component displays the resources worked on the task's start date and then completes. In decision block 625, if the task driver is a predecessor task, then the component continues at block 630, else the component continues at block 635. In block 630, the component lists the predecessor tasks affecting the task's start date and then completes. In decision block 635, if the task driver is a summary task, then the component continues at block 640, else the component continues at block 645. In block 640, the component displays information about the summary task and then completes. In decision block 645, if the task driver is leveling delay, then the component continues at block 650, else the component continues at block 655. In block 650, the component lists the leveling information and completes. In decision block 655, if the task driver is a subtask, then the component continues at block 660, else the component continues at block 665. In block 660, the component lists information about the subtasks affecting the task's start date and then completes. In decision block 665, if the task driver is a resource calendar, then the component continues at block 670, else the component completes. In block 670, the component lists information about the resource calendar and then completes. The task may also have drivers that are project or task calendars that are listed similarly to resource calendars.

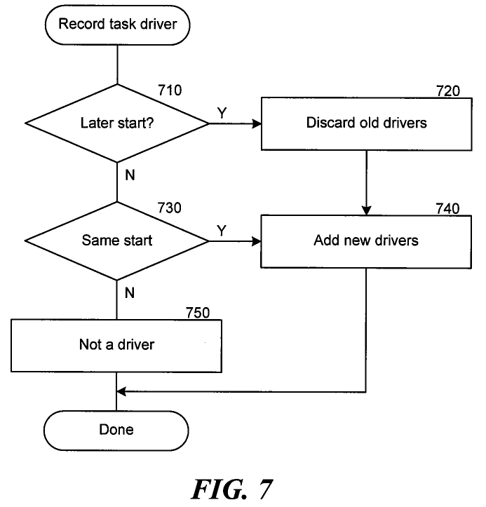

FIG. 7 is a flow diagram illustrating the processing of the scheduling engine component to record drivers in one embodiment. The component is invoked during scheduling to record information about drivers affecting the scheduling of a task. In decision block 710, if the driver causes the task to have a later start date, then the component continues at block 720, else the component continues at block 730. In block 720, the component discards any existing list of task drivers for the task. The component then continues at block 740. In decision block 730, if the driver causes the task to have the same start date, then the component continues at block 740, else the component continues at block 750. In block 740, the driver is appended to any existing list of drivers for the task. The component then completes. In block 750, the component determines that the driver is not currently affecting the scheduling of the tasks, and completes.

Although one method of recording drivers is described in FIG. 7, other methods could also be used. One alternative is to divide task drivers into three categories: solitary drivers, primary drivers, and contributory drivers. An actual start date is an example of a solitary driver, and causes all previous drivers to be thrown away, regardless of the effect on the start date. Predecessor tasks, constraints, project start dates, summary tasks, and child relationships are examples of primary drivers. These drivers cause the system to throw away the previous drivers only if the newly computed start date is later than the previous start date. Calendars and leveling delay are examples of contributory drivers. Although these may cause the start date to change, the system may add these to the list of drivers without discarding the previous list of drivers. In addition, in certain situations tasks may be scheduled from a finish date. For example, a task may have a date by which it must finish. In this case, the system processes each of the above decisions using the finish date instead of the start date.

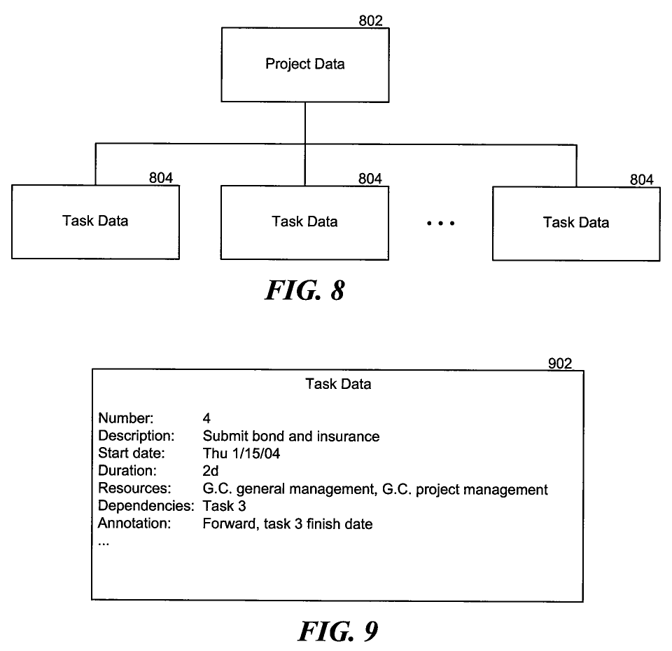

FIGS. 8-9 illustrate data structures associated with projects and tasks. The data structures may store data provided by a user using a user interface of the project management software, or other software using an API exposed by the project management software, and may also store data or other information produced or determined by the project management software. The data structures may be stored in primary or secondary storage.

FIG. 8 is a block diagram illustrating an embodiment of a data structure relating to a project and its tasks. Each project may have project-related data stored in a data structure associated with the project 802. As examples, project-related data may include a project name, a project start date, and project holidays. Project-related data may also include an indication of a number of tasks and their associated task-related data structures 804. Each task-related data structure comprises input data or other information relating to a task (further described below in relation to FIG. 9).

FIG. 9 is a block diagram illustrating an embodiment of a data structure relating to a task. The task data structure 902 may comprise input data and other information associated with a task. As examples, task-related data may include, e.g., a task number, description, start date, duration, resources assigned to the task, dependencies or constraints, and an annotation or explanation relating to the task's schedule. The task-related data may also comprise additional information (not shown). There may be a one-to-one correspondence between the number of task data structures to and the number of tasks associated with the project. In the illustrated embodiment, the task data structure 902 is shown containing data corresponding to task number 4. There may be additional task data structures for each of the other tasks in the project (not shown).

From the foregoing, it will be appreciated that specific embodiments of the task driver system have been described herein for purposes of illustration, but that various modifications may be made without deviating from the spirit and scope of the invention. For example, similar techniques could be used outside of the scope of project management. For example, drivers contributing to the selection of particular subcomponents for a hardware device, such as a video game console, could be analyzed to determine which components could be substituted to reduce the cost of the hardware device or enable increased performance. Similarly, the system could be used to analyze drivers contributing to routing decisions on the Internet, to select better routes for transmitting a packet. Accordingly, the invention is not limited except as by the appended claims.

I claim:

1. A method performed by a computing system for identifying drivers affecting the scheduling of tasks within a project, comprising:
receiving information defining each of a set of tasks for the project; and
for each task,
identifying scheduling considerations for the task;
determining a schedule for the task based on the identified considerations; and
storing information identifying a consideration that impacts the determined schedule for the task as a driver for the task.

2. The method of claim 1 wherein storing information includes adding the driver to an existing set of drivers when the driver produces the same scheduling date for the task as the existing drivers.

3. The method of claim 2 wherein the scheduling date is a start date.

4. The method of claim 2 wherein the scheduling date is an end date.

5. The method of claim 1 wherein storing information identifying a consideration as a driver comprises inspecting an existing set of drivers, and if the identified consideration produces a different scheduling date for the task, discarding the existing set of drivers.

6. The method of claim 5 wherein the scheduling date is a start date.

7. The method of claim 5 wherein the scheduling date is an end date.

8. The method of claim 1 wherein the identified consideration is selected from the set consisting of a constraint on the task, an actual start date for the task, and a predecessor task.

9. The method of claim 1 including displaying drivers of tasks so that a user can navigate through the drivers.

10. A user interface system for navigating tasks in a project having multiple tasks, comprising:
a task selection component for selecting a task; and
a task driver information component for displaying the drivers contributing to the schedule of the selected task.

11. The system of claim 10 wherein the task selection component receives input from a user indicating the currently selected task.

12. The system of claim 10 wherein the task driver information component displays multiple categories of drivers.

13. The system of claim 10 wherein the task driver information component only displays a maximum number of task drivers.

14. The system of claim 10 wherein the task driver information component receives a selection of a task driver and displays additional details about the selected task driver.

15. The system of claim 10 further comprising a task driver navigation component that maintains a chain of drivers that allows a user to navigate forward and backward through a list of related tasks affecting the scheduling of the selected task.

16. The system of claim 10 further comprising a scheduling component wherein the task driver information component registers a listener with the scheduling component to receive notification when a new task driver is identified for a task.

17. The system of claim 10 wherein the task driver information component provides a programmable object model such that programs can access task driver information programmatically.

18. A computer-readable medium containing a data structure employed for storing scheduling considerations for a project, the project having multiple tasks, the computer-readable medium comprising:
for each task,
a description for the task;
a list of constraints for the task;
a schedule for the task; and
a list of drivers contributing to the schedule for the task.

19. The computer-readable medium of claim 18 wherein the list of drivers includes multiple categories of drivers.

20. The computer-readable medium of claim 18 wherein each driver in the list of drivers includes a reference to a data structure comprising additional information about the task driver.
